(19) United States
(12) Patent Application Publication
(10) Pub. No.: US 2017/0139699 A1
(43) Pub. Date: May 18, 2017

(54) STORAGE DEVICE FLASHING OPERATION

(71) Applicant: Hewlett Packard Enterprise Development LP, Houston, TX (US)

(72) Inventor: Andy Brown, Houston, TX (US)

(21) Appl. No.: 15/325,783

(22) PCT Filed: Jan. 5, 2015
(86) PCT No.: PCT/US2015/010143

§ 371 Date: Jan. 12, 2017

(51) Int. Cl. G06F 9/445; G11B 5/024

(52) U.S. Cl. CPC G06F 8/65; G11B 5/0245

(57) ABSTRACT

An example hard disk drive includes a multiplexer. The multiplexer is coupled to a communication interface, a hard disk drive controller, and a storage device. The multiplexer is to, in response to a detection of a first selection command via a first set of pins of the communication interface, route first firmware data from a second set of pins of the communication interface to the storage device during a first flashing operation. The hard disk drive controller is bypassed during the routing of the first firmware data. The multiplexer is also to, in response to a detection of a second selection command via the first set of pins, route second firmware data from the hard disk drive controller to the storage device during a second flashing operation. The second firmware data is received via the third set of pins.

### BACKGROUND

Firmware data may be used to initialize and test components of an electronic device, such as a computing device, when the electronic device is turned on. The firmware data may also be used to control operations of the components. An example of firmware data may be basic input/output system (BIOS) of a computing device.

### BRIEF DESCRIPTION OF THE DRAWINGS

Some examples of the present application are described with respect to the following figures:

FIG. 1 is a block diagram of a hard disk drive including a multiplexer to route firmware data from a communication interface during a flashing operation, according to an example;

FIG. 2 is a block diagram of the hard disk drive of FIG. 1, according to another example;

FIG. 3 is a is a block diagram of a computing device to provide firmware data to a communication interface of a hard disk drive during a flashing operation, according to an example; and

FIG. 4 is a flowchart illustrating a method of operation at a hard disk drive including a multiplexer to route firmware data via a communication interface during a flashing operation, according to an example.

### DETAILED DESCRIPTION

An example electronic device that uses firmware data to control operations of components of the electronic device may be a hard disk drive. A hard disk drive may store firmware data in a non-volatile store device of the hard disk drive, such as flash memory. Existing firmware data may be updated or replaced via a flashing operation. As used herein, a flashing operation may be an operation where the existing firmware data is overwritten with new firmware data. For example, when existing firmware data is corrupted, the existing firmware data may be replaced during a flashing operation.

However, when existing firmware data is corrupted (e.g., malicious processor executable instructions are stored in the existing firmware data), the corrupted firmware data may control the hard disk drive to not replace the malicious processor executable instructions during a flashing operation. Thus, an effectiveness of a flashing operation may be reduced.

Examples described herein provide a hard drive disk that includes a multiplexer to route firmware data via a communication interface to a storage device of the hard disk drive during a flashing operation. For example, a hard disk drive may include a communication interface including a first set of pins, a second set of pins, and a third set of pins. The hard disk drive may also include a multiplexer coupled to the communication interface and a hard disk drive controller coupled to the multiplexer. The hard disk drive may further include a storage device coupled to the multiplexer.

The multiplexer may, in response to a detection of a first selection command via the first set of pins, route first firmware data from the second set of pins to the storage device during a first flashing operation. The hard disk drive controller is bypassed during the routing of the first firmware data. The multiplexer may also, in response to a detection of a second selection command via the first set of pins, route second firmware data from the hard disk drive controller to the storage device during a second flashing operation. The second firmware may be received via the third set of pins. Thus, a plurality of paths may be used to route firmware data to the storage device during a flashing operation.

In some examples, the communication interface may be a serial AT attachment (SATA) interface. The first and second set of pins may correspond to a SATA power connector. The third set of pins may correspond to a SATA data connector. In this manner, examples described herein may increase an effectiveness of a flashing operation.

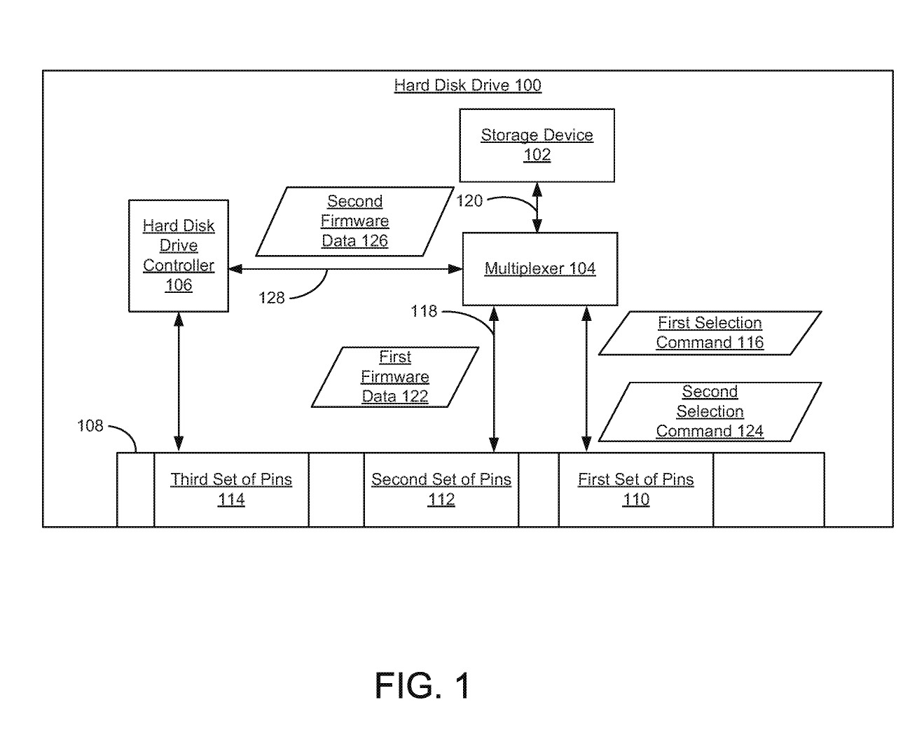

Referring now to the figures, FIG. 1 is a block diagram of a hard disk drive 100 including a multiplexer to route firmware data from a communication interface during a flashing operation, according to an example. Hard disk drive 100, for example, a storage device that uses rotating platters to store data. Hard disk drive 100 may include a storage device 102, a multiplexer 104, a hard disk drive controller 106, and a communication interface 108,

Storage device 102 may be any circuit or electronic device that stores data. In some examples, storage device 102 may be a non-volatile storage device that retains data even when not powered. As an example, storage device 102 may be flash memory implemented using negative-AND (NAND) or negative-OR (NOR) logic gates. As another example, storage device 102 may be ferroelectric memory. Storage device 102 may store firmware data that includes instructions executable by hard disk drive controller 106 to control operations of hard disk drive 100, such as initializing and testing components of hard disk drive 100 and storing data to hard disk drive 100.

Multiplexer 104 may be a circuit that selects one of a plurality of firmware data inputs and routes the selected firmware data input to storage device 102. Multiplexer 104 may be coupled to storage device 102, hard disk drive controller 106, and communication interface 108 via electrical connections.

Hard disk drive controller 106 may be a semiconductor-based microprocessor and/or other hardware device suitable for retrieval and execution of instructions stored as part of firmware data in storage device 102. Hard disk drive controller 106 may control operations of hard disk drive 100 via the firmware data.

Communication interface 108 may be an interface that receives both data and power from an external source. In some examples, communication interface 108 may be implemented using the SATA standard. Thus, communication interface 108 may be a SATA interface. Communication interface 108 may include a plurality of pins, such as a first set of pins 110, a second set of pins 112, and a third set of pins 114. In some examples, first set of pins 110 and second set of pins 112 may correspond to a SATA power connector. Third set of pins 114 may correspond to a SATA data connector. Thus, hard disk drive 100 may receive power via first set of pins 110 and/or second set of pins 112 and may receive data to be stored in hard disk drive 100 via third set of pins 114.

When the firmware data stored in storage device 102 is to he updated or replaced, a flashing operation may be performed on storage device 102 to update or replace the firmware data. As described in more detail below, multiplexer 104 may determine the routing of new firmware data to storage device 102 based on a selection command detected via communication interface 108.

During operation, multiplexer 104 may detect a selection command via first set of pins 110. When the selection command is a first selection command 116, multiplexer 104 may set a first routing path from second set of pins 112 to storage device 102 via multiplexer 104. The first routing path may include a connection 118 that couples second set of pins 112 to multiplexer 104 and a connection 120 that couples multiplexer 104 to storage device 102.

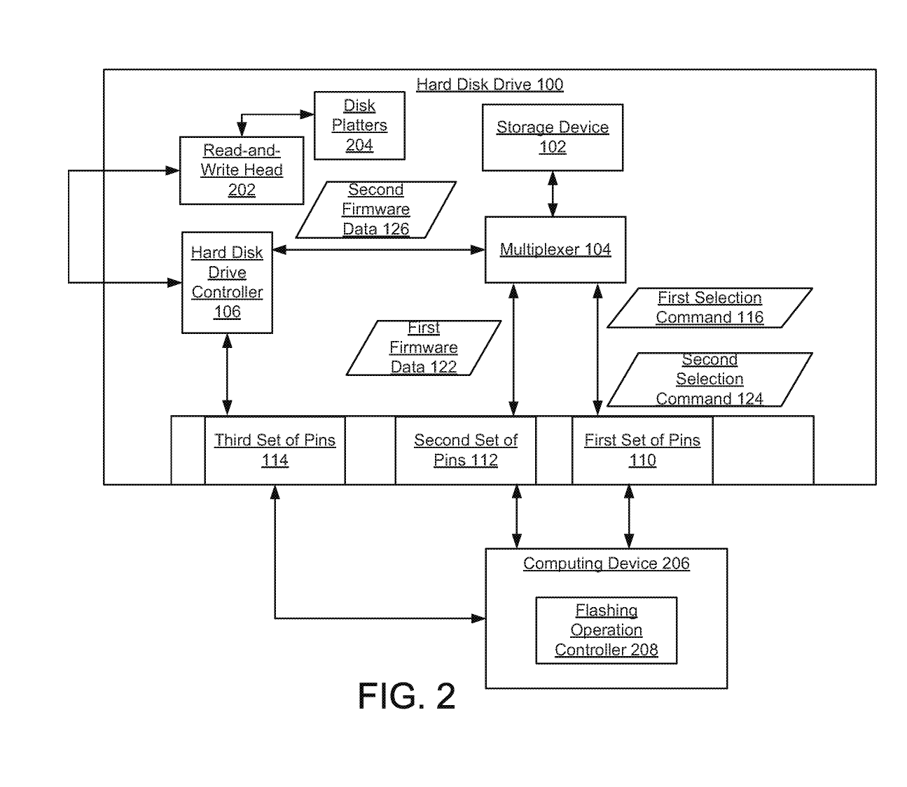

During a first flashing operation that is performed by a flashing operation controller (not shown in FIG. 1) external to hard disk drive 100, when hard disk drive 100 detects first firmware data 122 via second set of pins 112, multiplexer 104 may route first firmware data 122 to storage device 102 via the first routing path so that first firmware data 122 may replace existing firmware data stored in storage device 102. Thus, hard disk drive controller 106 is bypassed during the routing of first firmware data 122. That is, first firmware data 122 is not routed through hard disk drive controller 106 during the first flashing operation. By performing the first flashing operation via the flashing operation controller and bypassing hard disk drive controller 106, a likelihood that compromised firmware data in storage device 102 affecting the effectiveness of the a flashing operation may be reduced. The flashing operation controller is described in more detail in FIG. 2.

When the selection command is a second selection command 124, multiplexer 104 may set a second routing path from hard disk drive controller 106 to storage device 102 via multiplexer 104. The second routing path may include a connection 128 that couples hard disk drive controller 106 to multiplexer 104 and connection 120.

During a second flashing operation that is performed by hard disk drive controller 106, hard disk drive controller 106 may receive second firmware data 126 via third set of pins 114. As described in more detail in FIG. 2, in some examples, second firmware data 126 may be transmitted by a computing device (not shown in FIG. 1). Hard disk drive controller 106 may perform the second flashing operation by overwriting the existing firmware data in storage device 102 with second firmware data 126. Thus, multiplexer 104 may route second firmware data 126 from hard disk drive controller 106 to storage device 102 via the second routing path.

In some examples, multiplexer 104 may detect selection commands 116 and 124 based on a detection of a distinct voltage level of a power source. A detection of first selection command 116 may correspond to a detection of a first voltage level by multiplexer 104. A detection of second selection command 124 may correspond to a detection of a second voltage level by multiplexer 104. The second voltage level is different from the first voltage level. As an example, first selection command 116 may be detected when a 5-volt power source supplied via pins 7-9 of a SATA power connector is detected. Second selection command 124 may be detected when a 12-volt power source supplied via pins 13-15 of the SATA power connector is detected.

In some examples, the different power sources may be used to power components of hard disk drive 100 so that different components may be powered on during a flashing operation. For example, hard disk drive controller 106 may be powered by a power source different from multiplexer 104 and storage device 102. As an example, hard disk drive controller 106 may be powered by the 12-volt power source while multiplexer 104 and storage device 102 may be powered by the 5-volt power source. Thus, hard disk drive controller 106 may be powered off during the first flashing operation so that hard disk drive controller 106 may be bypassed. Hard disk drive controller 106 may be powered on during the second flashing operation. Multiplexer 104 and storage device 102 may be powered on during the first and second flashing operations.

In some examples, multiplexer 104 may detect selection commands 116 and 124 based on the presence of distinct of power sources. A detection of first selection command 116 may correspond to a detection of a single voltage level indicating the presence of a single power source and a detection of second selection command 124 may correspond to a detection of a plurality of voltage levels indicating the presence of a plurality of power sources or vice versa. For example, first selection command 116 may be detected when the 5-volt power source is detected. Second selection command 124 may be detected when the 12-volt power source and the 5-volt power source are detected.

In some examples, storage device 102 may be coupled to another storage device (not shown in FIG. 1) where first firmware data 122 and/or second firmware data 126 is stored. Thus, first firmware data 122 and/or second firmware data 126 may be routed through storage device 102 to the other storage device.

FIG. 2 is a block diagram of hard disk drive 100 of FIG. 1, according to another example, Hard disk drive 100 may further include a read-and-write head 202 and a plurality of disk platters 204. Based on firmware data stored in storage device 102 (e.g., first firmware data 122 or second firmware data 126), hard disk drive controller 106 may use read-and-write head 202 to store and/or retrieve data from the plurality of disk platters 204.

A computing device 206 may be coupled to hard disk drive 100 via first set of pins 110 and second set of pins 112. Computing device 206 may be, for example, a web-based server, a local area network server, a cloud-based server, a notebook computer, a desktop computer, an all-in-one system, a tablet, a mobile phone, an electronic book reader, or any other electronic device suitable interfacing with a hard disk drive (e.g., storing data in a hard disk drive). Computing device 206 may include a flashing operation controller 208.

Flashing operation controller 208 may be a central processing unit (CPU), a semiconductor-based microprocessor, and/or other hardware devices suitable for retrieval and execution of instructions stored in computer-readable storage medium (not shown in FIG. 2). Computing device 206 may use flashing operation controller 208 to perform the first flashing operation via second set of pins 112. Thus, flashing operation controller 208 may operate (e.g., perform the first flashing operation) without relying upon content of storage device 102. Flashing operation controller 208 may also operate without the correct operation (not corrupted) of firmware data stored in storage device 102.

Flashing operation controller 208 may assert first selection command 116 to multiplexer 104 via first set of pins 110. Flashing operation controller 208 may also perform the first flashing operation by transmitting first firmware data 122 to storage device 102 according to a serial peripheral interface (SPI) standard via second set of pins 112, For example, second set of pins 112 may correspond to pins 1-3 and 11 of the SATA power connector. Flashing operation controller 208 may assert second selection command 124 to multiplexer 104 via first set of pins 110. During the second flashing operation, hard disk drive controller 106 may access computing device 206 to obtain second firmware data 126 via third set of pins 114. In some examples, another computing device (not shown in FIG. 2) may be coupled to hard disk drive 100 via communication interface 108 to assert second selection command 124.

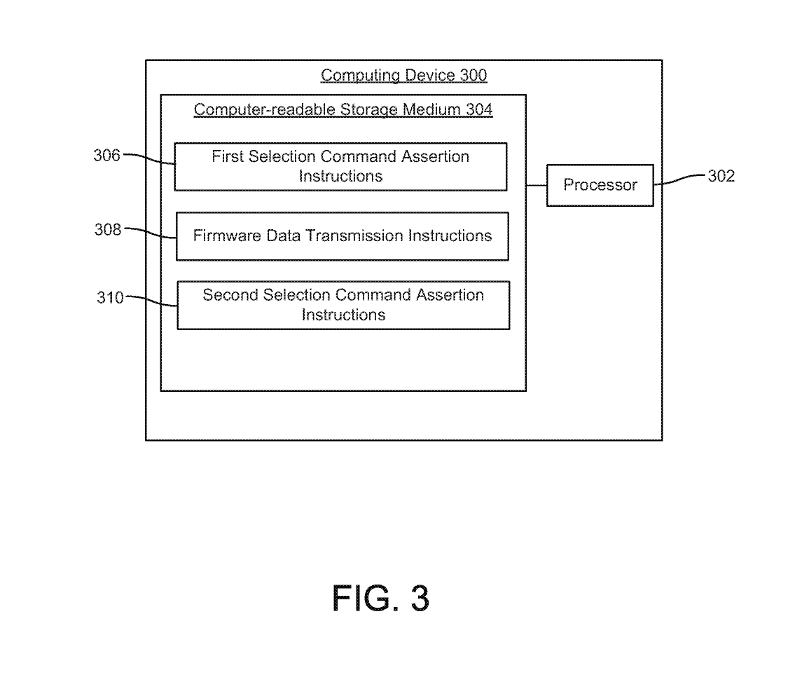

FIG. 3 is a is a block diagram of a computing device 300 to provide firmware data to a communication interface of a hard disk drive during a flashing operation, according to an example. Computing device 300 may implement computing device 206 of FIG. 2. Computing device 300 may include a processor 302 and a computer-readable storage medium 304.

Processor 302 may implement flashing operation controller 208 of FIG. 2. Processor 302 may be a central processing unit (CPU), a semiconductor-based microprocessor, and/or other hardware devices suitable for retrieval and execution of instructions stored in computer-readable storage medium 304. Processor 302 may fetch, decode, and execute instructions 306, 308, and 310 to control a process of asserting a selection command to a hard disk drive, such as hard disk drive 100 of FIGS. 1-2, and transmitting firmware data to the hard disk drive. As an alternative or in addition to retrieving and executing instructions, processor 302 may include at least one electronic circuit that includes electronic components for performing the functionality of instructions 306, 308, 310, or a combination thereof.

Computer-readable storage medium 304 may be any electronic, magnetic, optical, or other physical storage device that contains or stores executable instructions. Thus, computer-readable storage medium 304 may be, for example, Random Access Memory (RAM), an Electrically Erasable Programmable Read-Only Memory (EEPROM), a storage device, an optical disc, etc. In some examples, computer-readable storage medium 304 may be a non-transitory storage medium, where the term “non-transitory” does not encompass transitory propagating signals. Computer-readable storage medium 304 may be encoded with a series of processor executable instructions 306, 308, and 310 for asserting a selection command, such as first selection command 116, to a hard disk drive, transmitting firmware data to the hard disk drive, and asserting another selection command, such as second selection command 124, to the hard disk drive.

First selection command assertion instructions 306 may assert a first selection command to a multiplexer of a hard disk drive to set up a first routing path. For example, referring to FIG. 2, flashing operation controller 208 may assert first selection command 116 to multiplexer 104 via first set of pins 110. Firmware data transmission instructions 308 may transmit firmware data from a controller to a storage device of a hard disk drive. For example, referring to FIG. 2, during the first flashing operation, flashing operation controller 208 may transmit first firmware data 122 to storage device 102 according to the SPI standard via second set of pins 112. Second selection command instructions 310 may assert a second selection to the multiplexer to set up a second routing path different from the first routing path. For example, referring to FIG. 2, flashing operation controller 208 may assert second selection command 124 to multiplexer 104 via first set of pins 110.

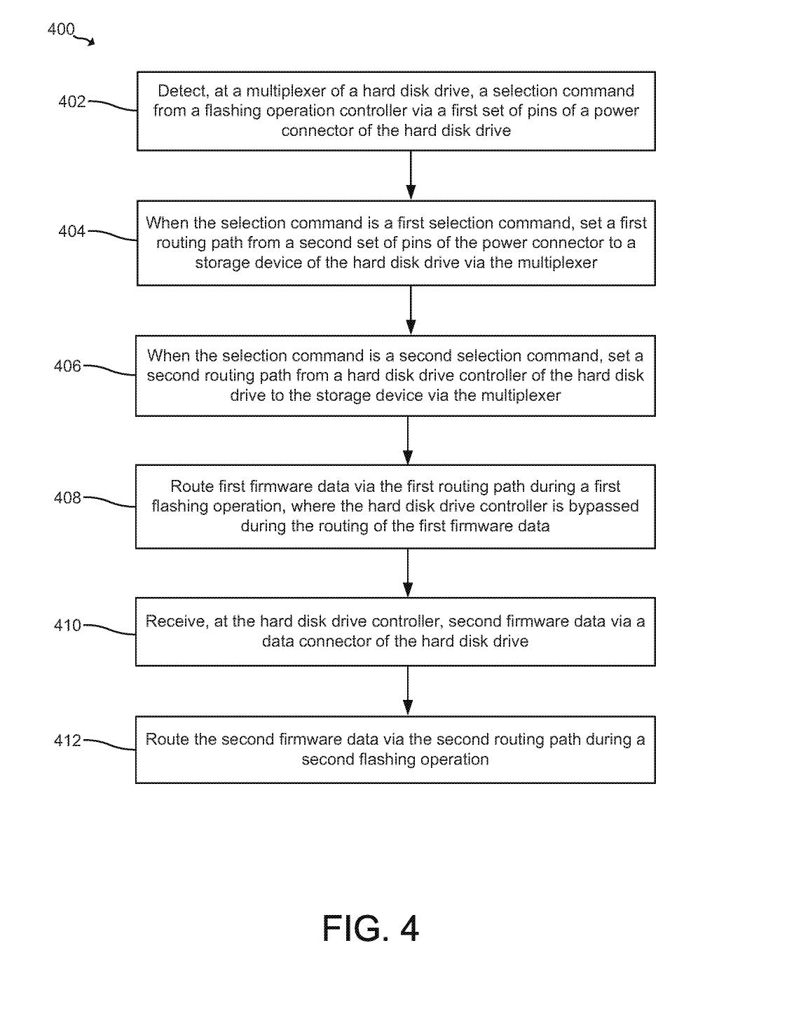

FIG. 4 is a flowchart illustrating a method 400 of operation at a hard disk drive including a multiplexer to route firmware data via a communication interface during a flashing operation, according to an example. Method 400 may be implemented using hard disk drive 100 of FIGS. 1-2. Method 400 includes detecting, at a multiplexer of a hard disk drive, a selection command from a flashing operation controller via a first set of pins of a power connector of the hard disk drive, at 402. For example, referring to FIG. 1, multiplexer 104 may detect first selection command 116 and second selection command 124 via first set of pins 110. Method 400 also includes when the selection command is a first selection command, setting a first routing path from a second set of pins of the power connector to a storage device of the hard disk drive via the multiplexer, at 404. For example, referring to FIG. 1, based on first selection command 116, multiplexer 104 may set a first routing path from second set of pins 112 to storage device 102 via multiplexer 104.

Method 400 further includes when the selection command is a second selection command, setting a second routing path from a hard disk drive controller of the hard disk drive to the storage device via the multiplexer, at 406. For example, referring to FIG. 1, based on second selection command 124, multiplexer 104 may set a second routing path from hard disk drive controller 106 to storage device 102 via multiplexer 104. Method 400 further includes routing first firmware data via the first routing path during a first flashing operation, where the hard disk drive controller is bypassed during the routing of the first firmware data, at 408. For example, referring to FIG. 1, multiplexer 104 may route first firmware data 122 to storage device 102 via the first routing path so that first firmware data 122 may replace existing firmware data stored in storage device 102.

Method 400 further includes receiving, at the hard disk drive controller, second firmware data via a data connector of the hard disk drive, at 410. For example, referring to FIG. 1, hard disk drive controller 106 may receive second firmware data 126 via third set of pins 114. Method 400 further includes routing the second firmware data via the second routing path during a second flashing operation, at 412. For example, referring to FIG. 1, multiplexer 104 may route second firmware data 126 from hard disk drive controller 106 to storage device 102 via the second routing path.

The use of “comprising”, “including” or “having” are synonymous and variations thereof herein are meant to be inclusive or open-ended and do not exclude additional unrecited elements or method steps.

What is claimed is:

1. A hard disk drive comprising:
a communication interface including a first set of pins, a second set of pins, and a third set of pins;
a multiplexer coupled to the communication interface;
a hard disk drive controller coupled to the multiplexer;
a storage device coupled to the multiplexer, wherein the multiplexer is to:
in response to a detection of a first selection command via the first set of pins, route first firmware data from the second set of pins to the storage device during a first flashing operation, wherein the hard disk drive controller is bypassed during the routing of the first firmware data; and
in response to a detection of a second selection command via the first set of pins, route second firmware data from the hard disk drive controller to the storage device during a second flashing operation, wherein the second firmware data is received via the third set of pins.

2. The hard disk drive of claim 1, wherein the detection of the first selection command corresponds to a detection of a first voltage level, wherein the detection of the second selection command corresponds to a detection of a second voltage level, and wherein the second voltage level different from the first voltage level.

3. The hard disk drive of claim 1, wherein the first flashing operation is performed by a flashing operation controller external to the hard disk drive, and wherein the second flashing operation is performed by the hard disk drive controller.

4. The hard disk drive of claim 1, wherein the third set of pins is coupled to the hard disk drive controller, the hard disk drive controller to receive the second firmware data from the third set of pins during the second flashing operation.

5. The hard disk drive of claim 1, further comprising a read-and-write head, and wherein the firmware data includes instructions that, when executed by the hard disk drive controller, cause the hard disk drive controller to control operations of the read-and-write head.

6. A method comprising:
detecting, at a multiplexer of a hard disk drive, a selection command from a flashing operation controller via a first set of pins of a power connector of the hard disk drive;
when the selection command is a first selection command, setting a first routing path from a second set of pins of the power connector to a storage device of the hard disk drive via the multiplexer;
when the selection command is a second selection command, setting a second routing path from a hard disk drive controller of the hard disk drive to the storage device via the multiplexer;
routing first firmware data via the first routing path during a first flashing operation, wherein the hard disk drive controller is bypassed during the routing of the first firmware data;
receiving, at the hard disk drive controller, second firmware data via a data connector of the hard disk drive; and
routing the second firmware data via the second routing path during a second flashing operation.

7. The method of claim 6, wherein the selection command is the first selection command when a single voltage level is detected via the first set of pins, and wherein the selection command is the second selection command when a plurality of voltage levels is detected via the first set of pins.

8. The method of claim 7, wherein the plurality of voltage level includes a first voltage level of 5 volts and a second voltage level of 12 volts, and wherein the single voltage level is one of the first voltage level and the second voltage level.

9. The method of claim 6, wherein the selection command is the first selection command when a first voltage level is detected, and wherein the selection command is the second selection command when a second voltage level is detected.

10. The method of claim 6, further comprising:
performing the first flashing operation using the flashing operation controller external to the hard disk drive; and
performing the second flashing operation using the hard disk drive controller.

11. The method of claim 6, wherein the hard disk drive controller is powered off during the first flashing operation.

12. A non-transitory computer-readable storage medium comprising instructions that when executed cause a processor of a computing device to:
assert a first selection command to a multiplexer of a hard disk drive to set a first routing path via a first set of pins of a power connector of the hard disk drive, wherein the first routing path is from a second set of pins of the power connector to a storage device of the hard disk drive via the multiplexer, wherein a hard disk drive controller of the hard disk drive is bypassed during a routing of data via the first routing path;
transmit first firmware data to the storage device via the first routing path during a first flashing operation; and
assert a second selection command to the multiplexer to set a second routing path via the first set of pins, wherein the second routing path is from the hard disk drive controller to the storage device, and wherein second firmware is routed via the second routing path during a second flashing operation.

13. The non-transitory computer-readable storage medium of claim 12, wherein the instructions when executed further cause the processor to transmit the first firmware data according to a serial peripheral interface (SPI) standard.

14. The non-transitory computer-readable storage medium of claim 12, wherein the first selection command corresponds to a first voltage level, and wherein the second selection command corresponds to a second voltage level different from the first voltage level.

15. The non-transitory computer-readable storage medium of claim 12, wherein the hard disk drive controller is powered off during the first flashing operation.
